(19) United States
(12) Patent Application Publication
(10) Pub. No.: US 2022/0221355 A1
(43) Pub. Date: Jul. 14, 2022

(54) SENSING FIBERS FOR STRUCTURAL HEALTH MONITORING

(71) Applicant: MESOMAT INC., Hamilton (CA)

(72) Inventors: Paul Fowler, Hamilton (CA); Clare Lindsay Armstong, Hamilton (CA); Karolyi J.T. Dalnoki-Veress, Hamilton (CA)

(21) Appl. No.: 17/429,901

(22) PCT Filed: Jan. 28, 2020
(86) PCT No.: PCT/IB2020/050666

§ 371 Date: Aug. 10, 2021

Related U.S. Application Data
(60) Provisional application No. 62/803,865, filed on Feb. 11, 2019.

(51) Int. Cl. G01L 1/24; G01M 5/00; B64F 5/60

(52) U.S. Cl. CPC G01L 1/242; B64F 5/60; G01M 5/0016

(57) ABSTRACT

Example systems, devices, and methods for structural strain monitoring that involve sensing fibers are disclosed. An example system includes a structural body and a sensing fiber that extends through the structural body and that exhibits an electrical resistance that varies with deformation of the sensing fiber. The system further includes a processing unit to monitor the electrical resistance of the sensing fiber, determine a structural strain experienced by the structural body based on the electrical resistance, and output an indication of the structural strain.

### FIELD

The present disclosure relates to structural health monitoring, and in particular, to sensors for monitoring structural strain.

### BACKGROUND

Structural health monitoring involves the monitoring of indicators of structural fatigue, failure, and fracture, in large infrastructure assets. Structural health monitoring may involve the use of sensors, such as accelerometers, strain gauges, displacement transducers, and other sensors, to collect data about a structural body (e.g. support column, roof of a building, wing of an aircraft). Such data may be analyzed for indications of strain or damage in the structural body.

### SUMMARY

According to an aspect of the disclosure, a system for structural strain monitoring is provided. The system includes a structural body and a sensing fiber that extends through the structural body. The sensing fiber exhibits an electrical resistance that varies with deformation of the sensing fiber. The system further includes a processing unit to monitor the electrical resistance of the sensing fiber, determine a structural strain experienced by the structural body based on the electrical resistance, and output an indication of the structural strain.

According to another aspect of the disclosure, a device for structural strain monitoring is provided. The device includes a sensing fiber that extends through a structural body. The sensing fiber exhibits an electrical resistance that varies with deformation of the sensing fiber. The device further includes a processing unit to monitor the electrical resistance of the sensing fiber, determine a structural strain experienced by the structural body based on the electrical resistance, and output an indication of the structural strain.

According to another aspect of the disclosure, a method for structural strain monitoring is provided. The method involves monitoring electrical resistance of a sensing fiber extending through the structural body. The sensing fiber exhibits an electrical resistance that varies with deformation of the sensing fiber. The method further involves determining a structural strain experienced by the structural body based on the electrical resistance and outputting an indication of the structural strain.

### BRIEF DESCRIPTION OF THE DRAWINGS

FIG. 1 is a schematic diagram of an example system for structural strain monitoring that includes a sensing fiber.

FIG. 2 is a flowchart of an example method for structural strain monitoring.

FIG. 3A is a schematic diagram of an example structural body under different circumstances of structural strain.

FIG. 3B is a deformation-resistance plot that shows a relationship between the deformation of a sensing fiber and the electrical resistance exhibited by the sensing fiber.

FIG. 4 is a schematic diagram of another example system for structural strain monitoring that includes a sensing fiber, the sensing fiber including a stretchable fiber core surrounded by electrically conductive mesh.

FIG. 5 is a schematic diagram of a cross-section of an example structural body with a sensing fiber.

FIG. 6A illustrates an example structural body with several sensing fibers fixed to a surface of the structural body.

FIG. 6B illustrates an example structural body with layers of composite material and sensing fibers embedded between the layers of composite material.

FIG. 7A illustrates an example wing of an aircraft with sensing fibers embedded therein.

FIG. 7B illustrates an example support column with sensing fibers embedded therein.

### DETAILED DESCRIPTION

The structural strain that is experienced by a structural body may be monitored using one or more point sensors (e.g. strain gauges) placed at specific points within or along the structural body. A point sensor monitors the local the deformations (e.g. bending, buckling) that take place around the point at which the point sensor is placed. For monitoring strains that cause larger deformations that span across a broader area of a structural body, a group of several point sensors may be placed at several different points spread throughout the broader area.

Although such a group of point sensors may provide limited information about a broad structural strain experienced across a broad area of a structural body, the completeness and the resolution of the structural strain information obtained by such sensors may be limited by the physical coverage of the point sensors. For example, a group of point sensor may miss information about a structural strain that is experienced directly at a gap between point sensors. As another example, even in the case of a larger strain that spans a broader area of the structural body, areas of the structural body in the gaps between the point sensors may contain important structural strain information that describes a characteristic of the larger strain, and this information may be missed.

An additional drawback of the use of point sensors embedded into a structural body is that such point sensors may compromise the structural integrity of the structural body itself. Due to the large size of conventionally used point sensors, these point sensors may create a point of failure, or weakness, within the structural body.

The present disclosure provides sensing fibers that may be used to more comprehensively monitor strains experienced by a structural body than a group of point sensors. As described herein, a structural body may be fitted with a sensing fiber that extends through a section of the structural body. The sensing fiber exhibits an electrical resistance that varies with deformation of the sensing fiber. Structural strain is determined by monitoring the electrical resistance across the sensing fiber as the structural body is deformed.

The sensing fiber reacts to strain experienced anywhere along its length, and thus structural strains experienced by the structural body may be monitored with fewer and/or smaller unmonitored gaps between sensors. The sensing fiber is a continuous sensor, and thus has no unmonitored gaps along its length. Several sensing fibers (e.g., in a mesh) may be placed throughout the structural body (e.g., in layers) to provide for broader (i.e., “global”) monitoring of the structural body. Further, the sensing fibers may be of sufficiently small size (i.e., thin), on a similar order as the size of fibers used in composite materials, and thus the sensing fibers may have a reduced impact on the structural integrity of the structural body when embedded in composite materials.

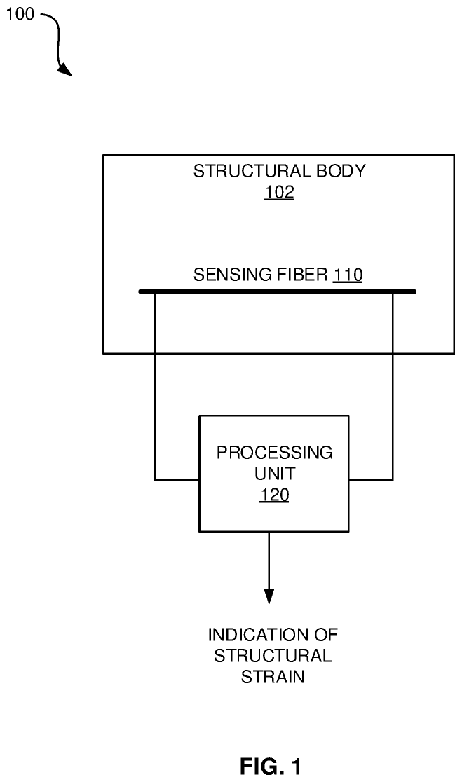

FIG. 1 is a schematic diagram of an example system 100 for structural strain monitoring. The system 100 includes a structural body 102, such as a wall, support column, structural cable, hull of a ship, body of a vehicle, wing of an aircraft, blade of a wind turbine, or any other structural body that may experience structural strain.

The system 100 further includes a sensing fiber 110 that extends through the structural body 102. That is, the sensing fiber 110 extends through at least a portion of the structural body 102, which may be referred to as the monitored section. The sensing fiber 110 may be embedded into the structural body 102 (i.e., embedded into the material of the structural body 102 during manufacture of the structural body 102). The structural body 102 may be made of a composite material of structural fibers into which the sensing fiber 110 is embedded alongside the other structural fibers. The sensing fiber 110 may be softer (i.e., of a low Young's modulus) than the materials into which it is embedded, and thus may act as a passive reporter of its surrounding structural environment while having little structural impact on its surroundings. The sensing fiber 110 may include a polymer-based fiber core, and thus may be sufficiently flexible to deform along with any deformations experienced by the structural body 102.

The sensing fiber 110 may span a majority of a dimension of interest (e.g., the entire length or width) of the structural body 102. For example, where the structural body 102 includes a wing of an aircraft, the sensing fiber 110 may span from the base of the wing to the tip of the wing, and therefore may monitor structural strains that would appear anywhere along the length of the wing.

The sensing fiber 110 is to exhibit an electrical resistance that varies with deformation of the sensing fiber 110. The sensing fiber 110 is electrically conductive along its entire length, and thus, the sensing fiber 110 may detect deformations that take place at any point along its length.

As the structural body 102 experiences a strain, the structural body 102 deforms, thereby causing the sensing fiber 110 to deform, and the electrical resistance exhibited by the sensing fiber 110 changes. Deformation of the sensing fiber 110 may refer to compression or elongation of the length of the sensing fiber 110.

The property that the sensing fiber 110 exhibits variable electrical resistance with deformation of the sensing fiber 110 may be referred to as its piezo-resistive property. The change in electrical resistance that is exhibited by the sensing fiber 110 may be sufficiently great to produce a signal that may be detected by a resistance measuring device. For example, elongation of the sensing fiber 110 by about 10% may result in a change in electrical resistance of about 40%.

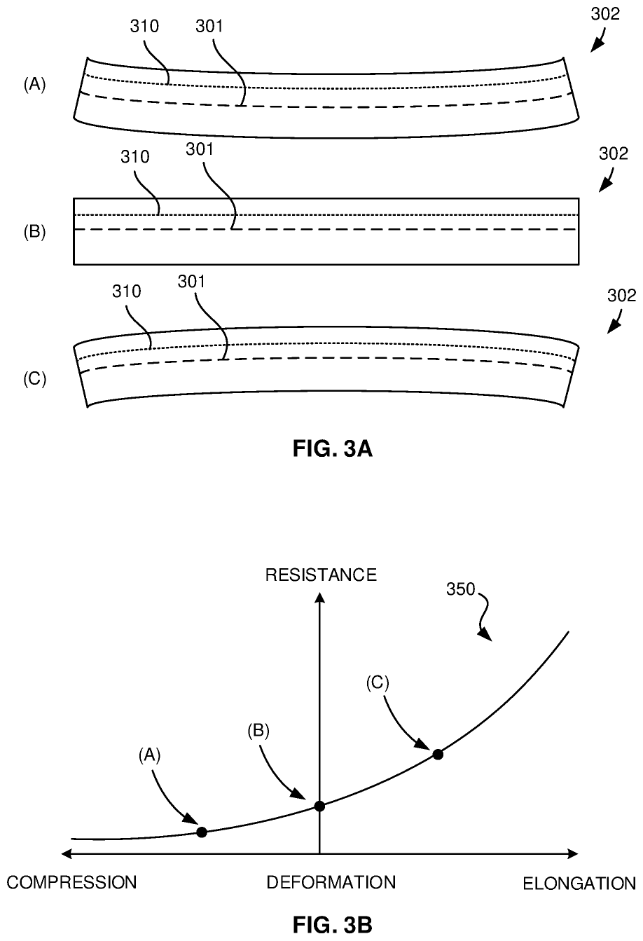

As described in greater detail with reference to FIGS. 3A-3B below, the change in electrical resistance may depend on the position of the sensing fiber 110 in the structural body 102 and the type of strain experienced by the structural body 102.

The system 100 further includes a processing unit 120. The processing unit is to monitor the electrical resistance of the sensing fiber 110, determine a structural strain experienced by the structural body 102 based on the electrical resistance, and output an indication of the structural strain.

In some examples, the processing unit 120 may include a data acquisition unit that monitors the electrical resistance, and may further include one or more computing devices (e.g. remote servers) which determine the structural strain and output the indication of structural strain. Thus, the processing unit 120 may include any quantity and combination of a processor, a central processing unit (CPU), a microprocessor, a microcontroller, a field-programmable gate array (FPGA), and similar, and may further include a memory (volatile and non-volatile storage) and/or communication interface (e.g. network interface), to perform the functionality as described herein.

The processing unit 120 may monitor the electrical resistance of the sensing fiber 110 through any suitable resistance-measuring device and electrical lead lines in contact with the sensing fiber 110. The electrical resistance may be monitored continuously or periodically by such a resistance-measuring device. Electrical resistance readings may be temporarily stored on the processing unit 120, either for processing, or for temporary storage prior to transmission to a remote device for processing.

The processing unit 120 may determine the structural strain based on one or more known relationships between measured electrical resistances of the sensing fiber 110 and corresponding deformations of the sensing fiber 110. That is, the sensing fiber 110 may have been tested to determine how an amount of deformation causes an amount of change in electrical resistance, or the sensing fiber 110 may have been manufactured to particular a specification which defines how the electrical resistance is to vary with deformation. Thus, the sensitivity of electrical resistance to deformation may be tuned to suit various applications. Such relationships may be expressed in a mathematical function (i.e., a mathematical function by which electrical resistance of the sensing fiber 110 may be calculated as a function of deformation), in a look-up table, or in other ways.

Further, the processing unit 120 may determine the structural strain based on one or more known relationships between deformations of the sensing fiber 110 and corresponding strains of the structural body 102. That is, the structural body 102 may have been tested to determine how an amount of strain causes an amount of deformation in the sensing fiber 110, or the structural body 102 may have been manufactured to a particular specification which defines how the deformation is to vary with strain. Again, such relationships may be expressed in a mathematical function (i.e., a mathematical function by strain experienced by the structural body 102 may be calculated as a function of deformation of the sensing fiber 110), in a look-up table, or in other ways.

Thus, a change in electrical resistance of the sensing fiber 110 may be related to a deformation in the sensing fiber 110, which in turn may be related to a strain on the structural body 102.

Although the relationship between the electrical resistance of a sensing fiber 110 and an amount of deformation of the sensing fiber 110 may be well understood (i.e., lab-tested), the relationship between an amount of deformation (or change in electrical resistance) of the sensing fiber 110 and an amount of structural strain actually experienced by the structural body 102 may be unique to the particular structural body 102, or, at least may be overly cumbersome to calculate directly for each structural body 102 that is to be monitored by a sensing fiber 110. Thus, in some examples, the processing unit 120 may determine the structural strain experienced by the structural body 102 by applying a machine learning model that is trained to determine the structural strain experienced by the structural body 102 based on the electrical resistance of the sensing fiber 110.

In practice, a structural body 102 having a sensing fiber 110 may undergo structural strain testing whereby the structural body 102 is placed under known strains (e.g. of different intensity and/or in different directions), and the resulting electrical resistances of the sensing fiber 110 may be measured. Thus, a relationship between electrical resistances of the sensing fiber 110 and strains on the structural body 102 may be determined. In the case of training a machine learning model, the strain data (that describes the structural strains that the structural body 102 was placed under) and the resistance data (that describes the electrical resistances of the sensing fiber 110 measured under those structural strains) may be fed into the machine learning model. The machine learning model may thereby be trained to predict structural strain of the structural body 102 based on electrical resistances of the sensing fiber 110. The machine learning model may be stored at the processing unit 120 and thus may provide predictions of structural strain experienced by the structural body 102.

Thus, a deformation of the structural body 102 may be reflected in deformation of the sensing fiber 110 and detected as a strain on the structural body 102. Further, in cases where electrical conductivity through the sensing fiber 110 is lost, the loss of conductivity may be interpreted as an indication of a break, crack, or fracture of the structural body 102.

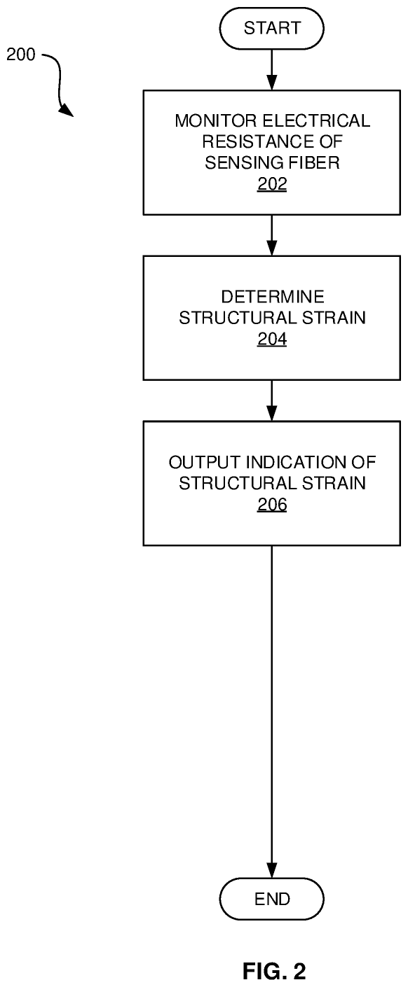

FIG. 2 is a flowchart of an example method 200 for structural strain monitoring. For convenience, the method 200 is described with reference to the system 100 of FIG. 1, and for further description of the blocks of the method 200, description of the system 100 of FIG. 1 may be referenced. However, this is not limiting, and the method 200 may be performed with other systems.

At block 202, the processing unit 120 monitors the electrical resistance of the sensing fiber 110. As discussed above, the sensing fiber 110 extends through the structural body 102 and exhibits an electrical resistance that varies with deformation of the sensing fiber 110. At block 204, the processing unit 120 determines the structural strain experienced by the structural body 102 based on the electrical resistance. At block 206, the processing unit 120 outputs an indication of the structural strain.

One or more of the blocks of the method 200 may be embodied in instructions stored on a non-transitory machine-readable storage medium that when executed causes a processor of a computing device (e.g. the processing unit 120 of FIG. 1) to perform the one or more blocks of the method 200. Thus, the processing unit 120 may be configured to perform one or more blocks of the method 200.

Turning to FIGS. 3A-3B, as mentioned above, the change in electrical resistance of the sensing fiber 110 may depend on the position of the sensing fiber 110 in the structural body 102 and the type of strain experienced by the structural body 102. FIG. 3A depicts schematic representations of a structural body 302 under three different circumstances of structural strain. The structural body 302 is similar to the structural body 102 of FIG. 1 and includes a sensing fiber 310 (shown in dotted lines) that is similar to the sensing fiber 110 of FIG. 1. The structural body 302 includes a neutral plane or median line 301 (shown in dashed lines) that bisects the structural body 302 lengthwise into a first half and a second half. The sensing fiber 310 is positioned in the first half of the structural body 302 and runs substantially parallel with the median line 301 along the length of the structural body 302.

In circumstance (A), the structural body 302 undergoes a strain that causes compression of the length of the first half of the structural body 302 (i.e., is deflected or bent upward), thereby causing compression of the length of the sensing fiber 310. In circumstance (B), the structural body 302 is in a neutral state under no strain, leaving the sensing fiber 310 at its neutral length. In circumstance (C), the structural body 302 undergoes a strain that causes elongation of the length of the first half of the structural body 302 (or compression of the second half of the structural body 302) (i.e., is deflected or bent downward), thereby causing elongation of the length of the sensing fiber 310.

FIG. 3B is a deformation-resistance plot showing a deformation-resistance curve 350 that describes a relationship between the electrical resistance of the sensing fiber 310 and deformation of the sensing fiber 310 in each of the circumstances (A), (B), and (C) described in FIG. 3A. The electrical resistance exhibited by the sensing fiber 310 increases as the length of the sensing fiber 310 increases (i.e., is elongated), and decreases as the length of the sensing fiber 310 decreases (i.e., is compressed).

At point (B), which corresponds to circumstance (B), the structural body 302 is under no strain, the sensing fiber 310 is at a neutral or initial length, and the sensing fiber 310 exhibits a neutral or initial electrical resistance. At point (A), which corresponds to circumstance (A), the structural body 302 is under a strain, the sensing fiber 310 is at a compressed length, and the sensing fiber 310 exhibits a compressed electrical resistance that is lower than the neutral or initial electrical resistance. At point (C), which corresponds to circumstance (C), the structural body 302 is under an opposite strain, the sensing fiber 310 is at an elongated length, and the sensing fiber 310 exhibits an elongated electrical resistance that is higher than the neutral or initial electrical resistance.

For each increment of length compression or elongation of the sensing fiber 310, the electrical resistance exhibited by the sensing fiber 310 is also incremented, and this relationship is described by the deformation-resistance curve 350 shown in FIG. 3B. The deformation-resistance curve 350 represents a known relationship between deformation of the sensing fiber 310 and electrical resistance of the sensing fiber 310 that may be used to determine the electrical resistance of the sensing fiber 310 at any given amount of deformation. The deformation-resistance curve 350 may be expressed in a mathematical function by which electrical resistance of the sensing fiber 310 may be calculated as a function of deformation. Although describes in terms of lengths of the structural body 302, it is to be understood that the principle described above applies to any deformation of any dimension of the structural body 302 (i.e., length, width, depth), or indeed any path through the structural body 302 which when deformed causes compression or elongation of the sensing fiber 310. In some examples, the sensing fiber 310 may be tested under circumstances similar to circumstances (A), (B), and (C), for the training of a machine learning model to determine the structural strain expensed by the structural body 302 based on electrical resistance of the sensing fiber 310, as described above.

In the example shown, the relationship between electrical resistance and deformation is non-linear. In particular, the electrical resistance of the sensing fiber 310 is more sensitive to deformations when the sensing fiber 310 is elongated than when the sensing fiber 310 is compressed. However, this is shown by way of example only, and the relationship between electrical resistance and deformation may be tuned to suit a given application.

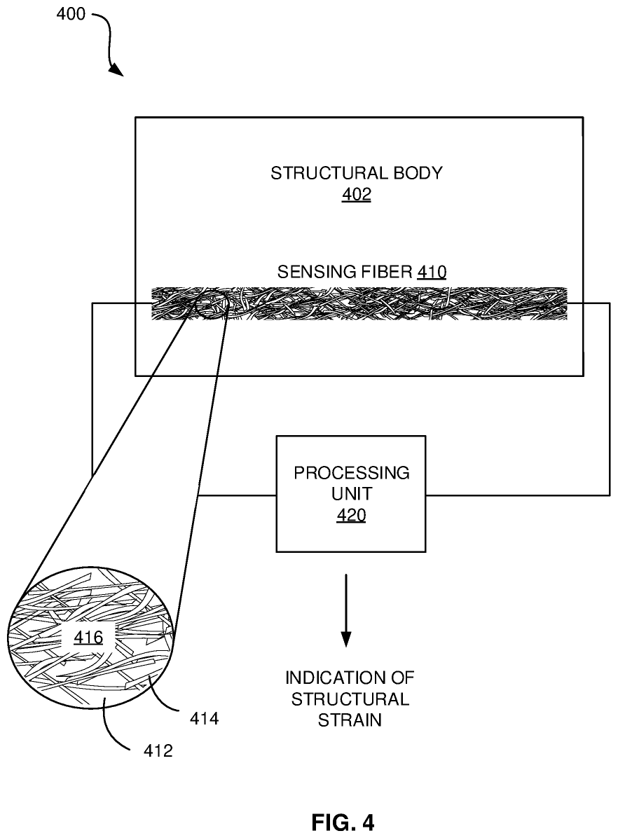

FIG. 4 is a schematic diagram of another system 400 of structural strain monitoring. The system 400 is similar to the system 100 of FIG. 1, with like components numbered in the “400” series rather than the “100” series, and includes a structural body 402, a sensing fiber 410, and a processing unit 420. For further description of these components, description of the like components in the system 100 of FIG. 1 may be referenced.

In the system 400, the sensing fiber 410 includes a stretchable fiber core 412 surrounded by an electrically conductive mesh 414, as described for example in PCT/IB2019/051634, which is incorporated herein by reference. The electrically conductive mesh 414 includes a plurality of high aspect ratio nanomaterials 416 coated around the stretchable fiber core 412 to conduct electricity across the sensing fiber 410. A portion of the sensing fiber 410 is magnified for clearer viewing of these components. Such sensing fibers 410 may be particularly thin (e.g., having diameter of 10 μm to 1 mm) so as to have minimal structural impact on the structural body 402 into which they are embedded.

The stretchable fiber core 412 is flexible and elastic, and thus the sensing fiber 410 reversibly deforms when the structural body 402 deforms. The electrically conductive mesh 414 increases in resistance as the high aspect ratio nanomaterials 416 are pulled apart from one another and decreases in resistance as the high aspect ratio nanomaterials 416 are brought closer together. Thus, the electrical resistance of the sensing fiber 410 decreases as the sensing fiber 410 is elongated and decreases as the sensing fiber 410 is compressed.

The stretchable fiber core 412 is stretchable in that it is flexible, bendable, deformable, and may be elongated or compressed to a substantial degree without breaking. The stretchable fiber core 412 may include a polymeric material, such as for example, one or a combination of polystyrene, poly(methyl methacrylate), poly(n-butyl methacrylate), polyamide, polyester, polyvinyl, polyolefin, acrylic polymer, nylon, polyurethane, and thermoplastic polyurethane (TPU). The stretchable fiber core 412 may be manufactured to have a radius of less than about 1 millimeter.

The high aspect ratio nanomaterials 416 may include slender nanomaterial deposits which are substantially greater in length than in width or diameter. When combined into the electrically conductive mesh 414, the high aspect ratio nanomaterials 416 are more thoroughly electrically connected when compressed together (and thus of lower resistance), and are less thoroughly electrically connected when elongated apart (and thus of higher resistance). The high aspect ratio nanomaterials 416 may have an average length-to-diameter aspect ratio of at least about 50:1, or more preferably at about 500:1, more preferably still about 1000:1, more preferably still 10,000:1. High aspect ratio nanomaterials 416 having an average length-to-diameter aspect ratio of about 1,000,000:1, or greater, may be used. The high aspect ratio nanomaterials 416 may have an average diameter of less than about 50 nanometers. The high aspect ratio nanomaterials 416 are electrically conductive, and thus may include metallic compounds or elements such as copper, silver, gold, platinum, iron in nanowire form, carbon nanotubes, other high aspect-ratio nanoparticles, and other high aspect-ratio nanomaterials.

The sensing fiber 410 may be coated with an electrically insulative material. The electrically insulative material may inhibit interference of the sensing fiber 410 with other components in the structural body 402. The electrically insulative material may further inhibit the sensing fiber 410 from short-circuiting with other sensing fibers 410 in the structural body 402, which may otherwise interfere with structural strain monitoring. The electrically insulative material may also be chemically resistant. Such an insulative material may include polystyrene, poly(methyl methacrylate), poly(n-butyl methacrylate), polyamides, polyesters, polyvinyls, polyolefins, acrylic polymers, polyurethanes or thermoplastic polyurethanes (TPU).

In some examples, the sensing fiber 410 may be wound into a yarn with several other sensing fibers 410, and similarly disposed on or in the structural body 402. A yarn of sensing fibers 410 may be more robust and reliable, especially when under strain, than a single sensing fiber 410.

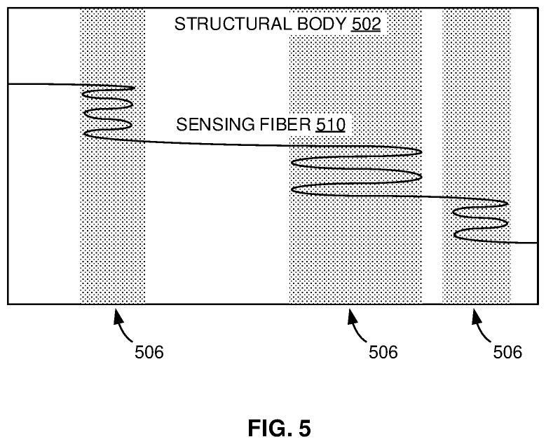

FIG. 5 is a schematic diagram of a cross-section of an example structural body 502 with a sensing fiber 510. These components may be similar to the structural body 102 and sensing fiber 110 of FIG. 1, and thus for further description of these components, the description of the like components of FIG. 1 may be referenced.

However, in the structural body 502, the sensing fiber 510 follows a path through the structural body 502 that passes through a section of the structural body 502 at least twice. As shown, the sensing fiber 510 passes through three enhanced-sensing sections 506 each at least twice. That is, the sensing fiber 510 doubles back or backtracks through these sections 506 more than once to provide “overlapping” sensing of these enhanced-sensing sections 506. During manufacture, when the sensing fiber 510 is embedded in the structural body 502, the sensing fiber 510 may be lain in a pathway that passes through such an enhanced-sensing section 506 at least twice (i.e., back and forth).

If there is a deformation in the structural body 502 in these enhanced-sensing sections 506, the sensing fiber 510 will undergo more extreme deformation than it would otherwise undergo in a section that it passes through only once, and thus the sensing fiber 510 will exhibit an increase or decrease (as the case may be) in electrical resistance to a greater degree in response to deformations in the structural body 502 in these enhanced-sensing sections 506 than it would otherwise exhibit in a section that it passes through only once. The sensing fiber 510 is therefore more sensitive to deformations in these enhanced-sensing sections 506 than it is to deformations elsewhere in the structural body 502.

In application, the sensing fiber 510 may be disposed in the structural body 502 as described above in sections that are of particularly high importance where it would be particularly useful to receive especially sensitive information about structural strain. Thus, the sensitivity of structural strain monitoring may be tuned by establishing such enhanced-sensing sections 506 in which sensing fibers 510 are particularly sensitive.

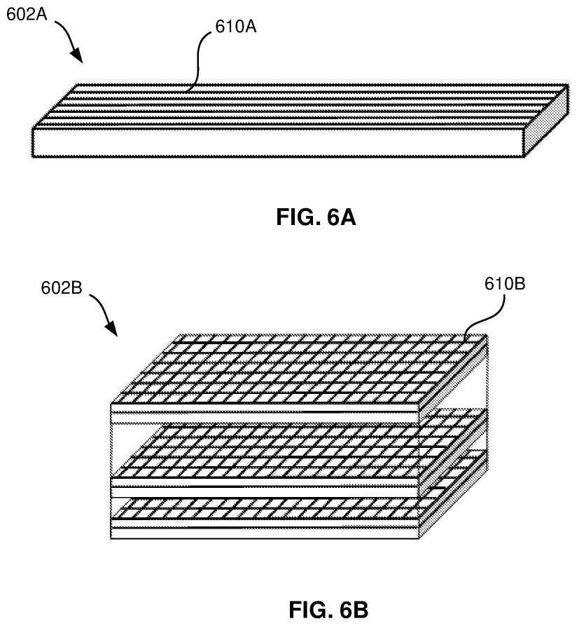

The sensing fibers discussed herein may be applied to a structural body in several ways. As shown for example in FIG. 6A, one or more sensing fibers 610A may be fixed (e.g., adhered) to a surface of a structural body 602A.

As another example as shown in FIG. 6B, a structural body 602B may include several layers of composite material in each of which several sensing fibers 610B are embedded. The sensing fibers 610B may be of similar size and flexibility as the fibers used in the composite material. Laying sensing fibers 610B may be incorporated into a layup procedure for preparing the composite materials.

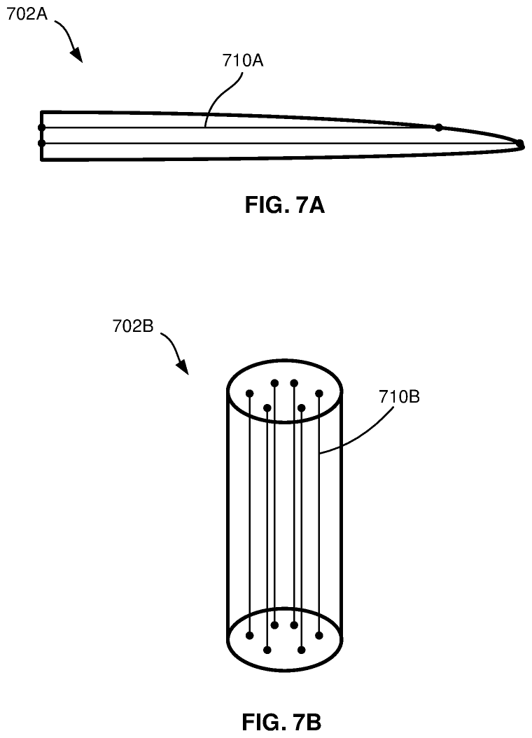

As yet another example, as shown in FIG. 7A, one or more sensing fibers 710A may be placed within a structural body 702A which is shown as a wing of an aircraft.

In yet another example, as shown in FIG. 7B, one or more sensing fibers 710B may be embedded within a structural body 702B which is shown as a support column or pillar.

Thus, sensing fibers may be provided for structural health monitoring applications. A sensing fiber may vary in electrical resistance when deformed by structural strains placed on a structural body, thereby providing a measure of structural strain. The sensing fibers may be made of low modulus materials which do not adversely affect the integrity of composite materials in which they are embedded, and thus can be safely embedded within structures while providing continuous structural monitoring of a large structural body. Sensing fibers may also be laid across a surface of a structural body, and may be adhered to the surface, to similarly monitor deformation of the material.

It should be recognized that features and aspects of the various examples provided above can be combined into further examples that also fall within the scope of the present disclosure. The scope of the claims should not be limited by the above examples but should be given the broadest interpretation consistent with the description as a whole.

1. A system comprising:
a structural body;
a sensing fiber that extends through the structural body, the sensing fiber to exhibit an electrical resistance that varies with deformation of the sensing fiber; and
a processing unit to:
monitor the electrical resistance of the sensing fiber;
determine a structural strain experienced by the structural body based on the electrical resistance; and
output an indication of the structural strain.

2. The system of claim 1, wherein the processing unit is to determine the structural strain experienced by the structural body by applying a machine learning model that is trained to determine the structural strain experienced by the structural body based on the electrical resistance of the sensing fiber.

3. The system of claim 1, wherein the sensing fiber is embedded into the structural body.

4. The system of claim 1, wherein the sensing fiber spans a monitored section of the structural body, the monitored section comprising a majority of a dimension of interest of the structural body.

5. The system of claim 1, wherein the sensing fiber follows a path through the structural body that passes through an enhanced-sensing section of the structural body at least twice.

6. The system of claim 1, wherein the structural body comprises a wing of an aircraft.

7. The system of claim 1, wherein the sensing fiber comprises a stretchable fiber core and an electrically conductive mesh, the electrically conductive mesh comprising a plurality of high aspect ratio nanomaterials coated around the stretchable fiber core to conduct electricity across the sensing fiber.

8. The system of claim 1, wherein the structural body comprises layers of composite material, and the sensing fiber is embedded between the layers of composite material.

9. A device comprising:
a sensing fiber that extends through a structural body, the sensing fiber to exhibit an electrical resistance that varies with deformation of the sensing fiber; and
a processing unit to:
monitor the electrical resistance of the sensing fiber;
determine a structural strain experienced by the structural body based on the electrical resistance; and
output an indication of the structural strain.

10. The device of claim 9, wherein the processing unit is to determine the structural strain experienced by the structural body by applying a machine learning model that is trained to determine the structural strain experienced by the structural body based on the electrical resistance of the sensing fiber.

11. The device of claim 9, wherein the sensing fiber comprises a stretchable fiber core and an electrically conductive mesh, the electrically conductive mesh comprising a plurality of high aspect ratio nanomaterials coated around the stretchable fiber core to conduct electricity across the sensing fiber.

12. A method comprising:
monitoring electrical resistance of a sensing fiber extending through the structural body, the sensing fiber exhibiting an electrical resistance that varies with deformation of the sensing fiber;
determining a structural strain experienced by the structural body based on the electrical resistance; and
outputting an indication of the structural strain.

13. The method of claim 12, wherein determining the structural strain comprises applying a machine learning model that is trained to determine the structural strain experienced by the structural body based on the electrical resistance of the sensing fiber.

14. The method of claim 12, further comprising, prior to monitoring the electrical resistance, manufacturing the structural body with the sensing fiber embedded through a monitored section of the structural body.

15. The method of claim 14, wherein manufacturing the structural body with the sensing fiber embedded through the monitored section comprises passing the sensing fiber through an enhanced-sensing section of the structural body at least twice.
